(19) United States
(12) Patent Application Publication
(10) Pub. No.: US 2005/0241162 A1
(43) Pub. Date: Nov. 3, 2005

(54) Biasing assembly for a razor and razor using same

(75) Inventors: Randy Nicolosi, Shelton, CT (US); Paul D. Richard, Shelton, CT (US)

Correspondence Address: Richard R Michaud;The Michaud-Duffy Group LLP, 306 Industrial Park Road Suite 206, Middletown, CT, 06457, US

(73) Assignee: Eveready Battery Company, Inc., Westlake, OH (US)

(21) Appl. No.: 10/834,413

(22) Filed: Apr. 29, 2004

(51) Int. Cl. B26B 21/00

(52) U.S. Cl. 30/531

(57) ABSTRACT

A biasing assembly for a wet shave razor is provided. The razor comprises a cartridge and a handle. The handle includes first and second connecting arms extending outwardly from the handle for pivotally coupling the cartridge to the handle for movement between a neutral position and a fully-rotated position. The biasing assembly includes an abutment surface defined by the cartridge and located on an underside thereof, and a biasing member extending outwardly from the handle and having an end which when the cartridge is coupled to the handle is in sliding engagement with the abutment surface such that as the cartridge moves between the neutral and fully-rotated positions, the biasing member exerts a variable torque against the abutment surface.

### FIELD OF THE INVENTION

This invention relates generally to wet shave razors, and more particularly relates to a biasing assembly for urging a rotatable razor cartridge towards an at-rest or neutral position.

### BACKGROUND OF THE INVENTION

Wet shave razors often employ pivotable razor cartridges that are rotatable relative to a handle on which the cartridge is either permanently or releasably mounted. Usually a biasing member or spring impinges on the cartridge urging it toward an initial or neutral position with respect to the handle. Historically, these springs tended to exert a rather large, restoring force with a limited range of rotation during a shaving operation. This in turn drove the blades housed in the cartridge into the user's skin. The large force exerted by the blades as the cartridge is drawn over the ever-changing contours of skin increases the likelihood of cuts, abrasion, and thereby shaving discomfort. Moreover, if the cartridge is configured so that it can cut hair when moved over a user's skin in either of two generally opposite directions, the large spring force coupled with the direction reversals further increases the likelihood of cutting the user's skin during a shaving operation.

When shaving contoured surfaces the low spring force prevents the cartridge from lifting off the skin as is common when stiffer springs are used.

Accordingly, it is a general object of the present invention to provide a biasing assembly for a razor and a razor using such biasing member which overcomes or improves upon the above-mentioned drawbacks.

### SUMMARY OF THE INVENTION

The present invention resides in a biasing assembly for a wet shave razor. The razor comprises a cartridge and a handle. The handle includes first and second connecting arms extending outwardly from the handle for pivotally coupling the cartridge to the handle for movement between a neutral position and a fully-rotated position. The biasing assembly includes an abutment surface defined by the cartridge and located on an underside thereof. A biasing member extends outwardly from the handle and has an end, which when the cartridge is mounted on the handle, is in sliding engagement with the abutment surface such that as the cartridge moves between the neutral and fully-rotated positions, the biasing member exerts a variable torque against the abutment surface. The biasing member preferably defines a cut-out portion to provide a proper balance between flexibility and strength. The abutment surface can take various practical shapes such as a cylindrical shape or an apex. In a preferred embodiment, the torque ranges from about 2.1 to about 11.5 gram force centimeters as the cartridge is pivoted from about 5° to about 70° relative to the neutral position.

An advantage of the present invention is that it reduces the need for fragment repositioning of the handle when shaving complex contoured surfaces.

### BRIEF DESCRIPTION OF THE DRAWINGS

FIG. 1 is a side view of a razor including a biasing member engaging a cartridge in a neutral position in accordance with the present invention.

FIG. 2 is a side view of the razor of FIG. 1 showing the biasing member engaging a cartridge in a fully-rotated position.

FIG. 3 is a front view of the biasing member.

FIG. 4 is a rear view of the biasing member.

FIG. 5 is a rear view of the cartridge.

FIG. 6 is a front view of the cartridge.

FIG. 7 is a front view of the razor of FIG. 1 showing the biasing member engaging the cartridge in the neutral position.

FIG. 8 is a rear view of the razor of FIG. 1 showing the biasing member engaging the cartridge in the fully-rotated position.

FIG. 9 is a rear view of a cartridge in accordance with another embodiment of the present invention.

### DETAILED DESCRIPTION OF THE PREFERRED EMBODIMENTS

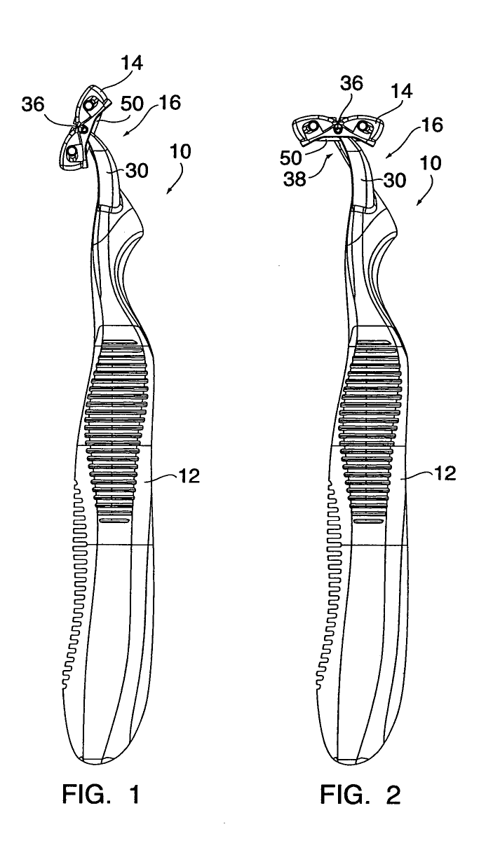

With reference to FIGS. 1 and 2, a wet shave razor including a biasing member embodying the present invention is indicated generally by the reference number 10. The razor 10 includes a handle 12 and a cartridge 14. The cartridge 14 is pivotally coupled to a head portion 16 of the handle 12 and is movable between a neutral position as shown in FIG. 1 and a fully-rotated position as shown in FIG. 2.

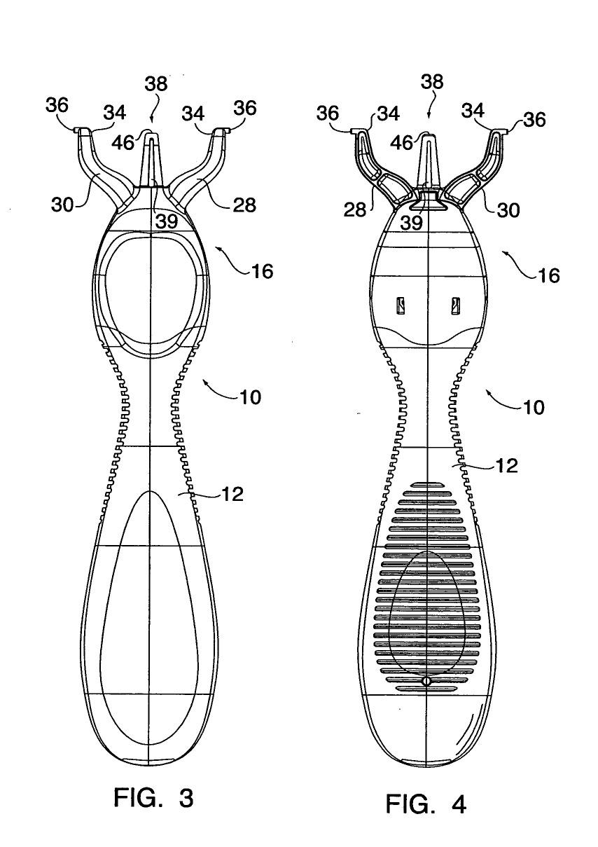

As shown in FIGS. 3 and 4, first and second connecting arms 28, 30 extend outwardly from the head portion 16. A distal end 34 of each of the first and second connecting arms 28, 30 includes a projection or pin 36 extending therefrom for pivotally engaging mating recesses defined by the cartridge 14 for movement about a pivot axis extending through the distal ends of the connecting arms.

While a projection 36 is shown and described as engaging mating recesses defined by the cartridge, the present invention is not limited in this regard as other types of connections known to those skilled in the art to which the invention pertains, such as, but not limited to shell bearings, or snap-type connections can also be employed.

A resilient biasing member 38 is interposed between the first and second connecting arms 28, 30 and extends outwardly from the head portion 16. In the illustrated embodiment, the biasing member 38 defines a cut-out portion 39 to balance flexibility and strength. However, the present invention is not limited in this regard as the biasing member 38 can also be solid, e.g. without the cut-out portion 39. Flexibility, and strength can then be controlled by, inter alia, adjusting the thickness of the biasing member.

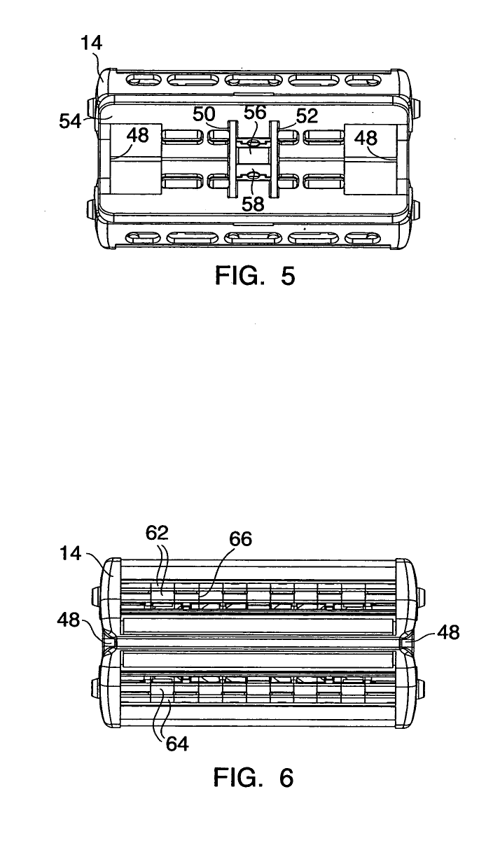

Turning now to FIGS. 5 and 6, the cartridge 14 defines openings or recesses 48 at sides thereof for pivotally receiving the pins 36 of the connecting arms 28, 30. The cartridge 14 further includes first and second guide portions 50, 52 depending from a rear surface 54 of the cartridge. An abutment surface 56 extends between the guide portions 50, 52. The abutment surface 56 and the rear surface 54 cooperate to define a slot 58 for receiving in sliding engagement the distal end 46 of the biasing member 38. The abutment surface 56 is preferably cylindrical, but may be rectangular, square, semi-cylindrical or other practical shapes without departing from the scope of the present invention. Moreover, the abutment surface is offset relative to the pivot axis of the cartridge.

As shown in FIG. 6, the cartridge 14 includes a first pair of blades 62 disposed at one end of the cartridge, and a second pair of blades 64 disposed at an opposite end to permit bidirectional shaving. The pairs of blades 62 and 64 are wrapped with wire 66 to prevent excessive extrusion of a user's skin between successive blades during a shaving operation. While the cartridge 14 has been shown and described as being bidirectional, that is, capable of cuffing hair when drawn over a user's skin in either of two generally opposite directions, the invention is not limited in this regard. For example, the cartridge can be unidirectional and have a different number of blades from those illustrated without departing from the scope of the present invention.

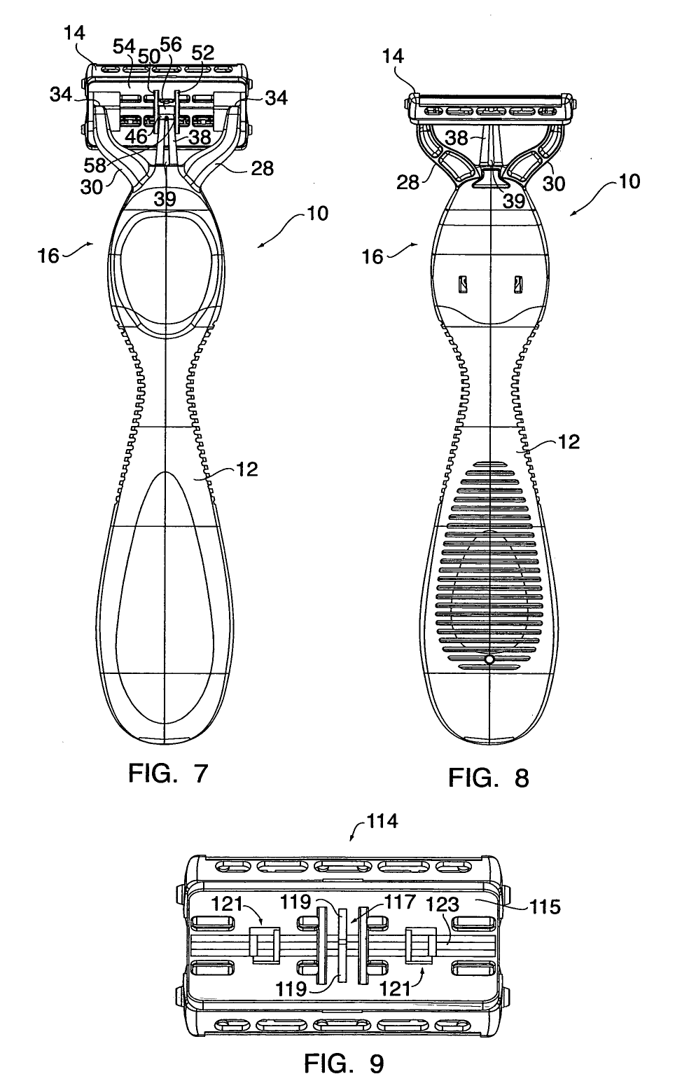

The operation of the razor 10 will now be explained. With respect to FIGS. 1 and 7, the razor 10 is shown with the cartridge 14 in a neutral position. The first and second connecting arms 28, 30 are pivotally engaged in the associated openings 48 defined by the sides of the cartridge 14. As shown in FIG. 7, the distal end 46 of the biasing member 38 is received within the slot 58 between the abutment surface 56 and the rear surface 54 of the cartridge 14. When in the neutral position, the biasing member 38 is generally unflexed and unbiased such that the distal end 46 of the biasing member is disposed generally along the pivot axis.

During a shaving operation, as the cartridge 14 is drawn over a user's skin, the cartridge pivots between the neutral position shown in FIGS. 1 and 7 and the fully-rotated position shown in FIGS. 2 and 8. This in turn causes the abutment surface 56 to move away from the pivot axis and impinge upon the biasing member 38 causing it to flex and thereby exert a variable torque against the abutment surface. This variable torque acts to normally urge the cartridge 14 toward the neutral position. The torque levels are such that the blades in the cartridge 14 are not excessively driven into the user's skin, yet the cartridge follows the contours of the skin. This reduces the likelihood of cutting the skin.

Although the cartridge 14 is shown and described as including the abutment surface 56 and the slot 58 for receiving in sliding engagement the biasing member 38, a cartridge for engaging the biasing member is not limited in this regard. With reference to FIG. 9, for example, a cartridge 114 has an underside 115 including a detent member 117. The detent member 117 is defined by two opposing inclined surfaces 119, 119 which cooperate to form an apex for receiving the biasing member in sliding engagement therein. The apex of the detent member 117 is disposed over a rail 123 extending along a central longitudinal axis of the cartridge 114. As the cartridge 114 pivots with respect to a handle during a shaving operation, the inclined surfaces 119, 119 of the detent member 117 serve as an abutment surface which impinges upon the biasing member causing it to flex and thereby exert a variable torque against the abutment surface. This variable torque acts to normally urge the cartridge 114 toward the neutral position in the manner previously described with respect to the cartridge 14 shown in FIG. 5.

Moreover, a cartridge in accordance with the present invention can be configured with other practical types of pivoting mechanisms without departing from the scope of the present invention. As shown in FIG. 9, for example, the cartridge 114 includes clam shell bearings 121, 121 for pivotally engaging a razor handle in a manner known to those skilled in the pertinent art.

Tests were performed using the above-described razor to determine the average torque applied by the biasing member to the cartridge. The average torque in gram force centimeters was determined from several tests taken as the cartridge pivoted in five degree increments from the neutral position (see FIG. 1) toward the fully-rotated position (see FIG. 2). The results are set forth as follows:

| Pivot Angle Relative to First Position | Average Torque |
|---|---|
| 5° | 2.109 |
| 10° | 3.343 |
| 15° | 3.582 |
| 20° | 4.696 |
| 25° | 5.254 |
| 30° | 5.453 |
| 35° | 6.647 |
| 40° | 7.244 |
| 45° | 7.323 |
| 50° | 8.278 |
| 55° | 9.273 |
| 60° | 11.064 |
| 65° | 11.064 |
| 70° | 11.423 |

As can be seen from the test results, as the cartridge pivots from the neutral position to the fully-rotated position, the torque generally gradually and progressively increases with the torque levels being such as to minimize the force exerted by the blades against the skin to thereby reduce the likelihood of cutting the skin, as well as the likelihood of cartridge tipping when shaving contoured surfaces.

As will be recognized by those of ordinary skill in the pertinent art, numerous modifications and substitutions may be made to the above-described embodiment of the present invention without departing from the scope of the invention. Accordingly, the preceding portion of this specification is to be taken in an illustrative, as opposed to a limiting sense.

1. A biasing assembly for a wet shave razor, said razor comprising:
a cartridge; and
a handle including first and second connecting arms extending outwardly from the handle for pivotally coupling the cartridge to the handle for movement between a neutral position and a fully-rotated position, the biasing assembly including:
an abutment surface defined by the cartridge and located on an underside thereof, and
a biasing member extending outwardly from the handle and having an end which when the cartridge is coupled to the handle is in sliding engagement with the abutment surface such that as the cartridge moves between the neutral and fully-rotated positions, the biasing member exerts a variable torque against the abutment surface.

2. A biasing assembly as defined in claim 1, wherein the abutment surface is generally cylindrical.

3. A biasing assembly as defined in claim 2, wherein the cartridge includes guide members depending from the rearward surface of the cartridge for supporting each end of the abutment surface.

4. A biasing assembly as defined in claim 1, wherein the abutment surface is defined by opposing inclined surfaces.

5. A biasing assembly as defined in claim 1, wherein the biasing member applies a progressively increasing torque to the abutment surface as the cartridge pivots from the neutral position to the fully-rotated position.

6. A biasing assembly as defined in claim 1, wherein the abutment surface is disposed generally centrally of the cartridge.

7. A biasing assembly as defined in claim 5, wherein a central longitudinally extending axis of the abutment surface is offset relative to a pivot axis of the cartridge when the cartridge.

8. A biasing assembly as defined in claim 1, wherein a distal end of the biasing member is disposed generally along a pivot axis of the cartridge when the biasing member is in the neutral position.

9. A biasing assembly as defined in claim 1, wherein the biasing member defines a cut-out portion.

10. A biasing assembly as defined in claim 1, wherein the cartridge defines recesses at the side portions, and wherein the first and second connecting arms each include a projection for being pivotally received in an associated one of the recesses.

11. A biasing assembly as defined in claim 10, wherein each of the projections includes a pin extending outwardly from an associated connecting arm.

12. A biasing assembly as defined in claim 1, wherein the torque ranges from about 2.109 to about 3.582 gram force centimeters as the cartridge is pivoted from about 5° to about 15° relative to the neutral position.

13. A biasing assembly as defined in claim 1, wherein the torque ranges from about 2.11 to about 5.42 gram force centimeters as the cartridge is pivoted from about 5° to about 30° relative to the neutral position.

14. A biasing assembly as defined in claim 1, wherein the torque ranges from about 2.11 to about 7.32 gram force centimeters as the cartridge is pivoted from about 5° to about 45° relative to the neutral position.

15. A biasing assembly as defined in claim 1, wherein the torque ranges from about 2.11 to about 11.06 gram force centimeters as the cartridge is pivoted from about 5° to about 60° relative to the neutral position.

16. A biasing assembly as defined in claim 1, wherein the torque ranges from about 2.11 to about 11.42 gram force centimeters as the cartridge is pivoted from about 5° to about 70° relative to the neutral position.

17. A biasing assembly as defined in claim 1, wherein the biasing member is solid.
